(19) United States
(12) Patent Application Publication
(10) Pub. No.: US 2025/0337072 A1
(43) Pub. Date: Oct. 30, 2025

(54) SYSTEMS AND METHODS FOR SEALING TRACTION BATTERY PACKS

(71) Applicant: FORD GLOBAL TECHNOLOGIES, LLC, Dearborn, MI (US)

(72) Inventors: Xiaogang ZHANG, Novi, MI (US); Samuel Jeffrey TOMLINSON, Farmington Hills, MI (US)

(21) Appl. No.: 18/648,870

(22) Filed: Apr. 29, 2024

(51) Int. Cl. H01M 50/24; B60L 50/60; F16L 59/02; H01M 10/625; H01M 10/658; H01M 50/209; H01M 50/249; H01M 50/262; H01M 50/271

(52) U.S. Cl. CPC H01M 50/24; F16L 59/026; H01M 10/625; H01M 10/658; H01M 50/209; H01M 50/249; H01M 50/262; H01M 50/271; B60L 50/60; H01M 2220/20

(57) ABSTRACT

Systems and methods are provided for sealing interfaces of a traction battery pack. An enclosure assembly of the traction battery pack may include a protective blanket configured for insulating portions of the enclosure assembly. A sealing portion of the protective blanket may be arranged to seal an interface between a first enclosure section and a second enclosure section of the enclosure assembly. The sealing portion may be compressed by one or more mechanical fasteners for sealing a gas exchange between an interior area of the enclosure assembly and an ambient environment outside of the enclosure assembly.

### TECHNICAL FIELD

This disclosure relates generally to electrified vehicle traction battery packs, and more particularly to sealing interfaces of a traction battery pack enclosure.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly including a first enclosure section and a second enclosure section, and a protective blanket positioned to line at least a portion of the first enclosure section or the second enclosure section. A sealing portion of the protective blanket is arranged to extend between a first peripheral flange of the first enclosure section and a second peripheral flange of the second enclosure section.

In a further non-limiting embodiment of the forgoing traction battery pack, a mechanical fastener is inserted through the first peripheral flange, the sealing portion, and the second peripheral flange.

In a further non-limiting embodiment of either of the foregoing traction battery packs, the mechanical fastener includes a bolt.

In a further non-limiting embodiment of any of the foregoing traction battery packs, the sealing portion is compressed between the first peripheral flange and the second peripheral flange by the mechanical fastener.

In a further non-limiting embodiment of any of the foregoing traction battery packs, a sealant is disposed between the first peripheral flange and the second peripheral flange at a location adjacent to the mechanical fastener.

In a further non-limiting embodiment of any of the foregoing traction battery packs, the first enclosure section is an enclosure cover, and the second enclosure section is an enclosure tray.

In a further non-limiting embodiment of any of the foregoing traction battery packs, the protective blanket lines an interior surface of the enclosure cover.

In a further non-limiting embodiment of any of the foregoing traction battery packs, the protective blanket lines an interior surface of the enclosure tray.

In a further non-limiting embodiment of any of the foregoing traction battery packs, the sealing portion is configured to seal a gas path that extends between the first peripheral flange and the second peripheral flange.

In a further non-limiting embodiment of any of the foregoing traction battery packs, the sealing portion includes a first thermally insulating layer, a second thermally insulating layer, and a third layer sandwiched between the first thermally insulating layer and the second thermally insulating layer.

In a further non-limiting embodiment of any of the foregoing traction battery packs, the third layer is a metallic layer or an additional thermally insulating layer.

In a further non-limiting embodiment of any of the foregoing traction battery packs, the first thermally insulating layer, the second thermally insulating layer, and the third layer cooperate to establish a geometric feature within the sealing portion.

In a further non-limiting embodiment of any of the foregoing traction battery packs, the geometric feature is established by an angled surface or an indentation formed in each of the first thermally insulating layer, the second thermally insulating layer, and the third layer.

A traction battery pack according to another exemplary aspect of the present disclosure includes, among other things, an enclosure assembly including a first enclosure section and a second enclosure section that cooperate to establish an interior area. A protective blanket is secured to an interior surface of at least one of the first enclosure section or the second enclosure section. A sealing portion of the protective blanket extends between a first peripheral flange of the first enclosure section and a second peripheral flange of the second enclosure section. The sealing portion is configured to seal a gas exchange between the interior area and an ambient environment outside of the enclosure assembly. A mechanical fastener is configured to compress the sealing portion between the first peripheral flange and the second peripheral flange.

In a further non-limiting embodiment of the foregoing traction battery pack, a first battery array and a second battery array are housed within the interior area.

In a further non-limiting embodiment of either of the foregoing traction battery packs, the first battery array is part of a first tier of battery arrays, and the second battery array is part of a second tier of battery arrays.

In a further non-limiting embodiment of any of the foregoing traction battery packs, the protective blanket is a mica sheet.

In a further non-limiting embodiment of any of the foregoing traction battery packs, a sealant is disposed between the first peripheral flange and the second peripheral flange at a location adjacent to the mechanical fastener.

In a further non-limiting embodiment of any of the foregoing traction battery packs, the sealing portion includes a first thermally insulating layer, a second thermally insulating layer, and a metallic layer sandwiched between the first thermally insulating layer and the second thermally insulating layer.

In a further non-limiting embodiment of any of the foregoing traction battery packs, the first thermally insulating layer, the second thermally insulating layer, and the metallic layer cooperate to establish a geometric feature within the sealing portion.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 is an exploded view of the traction battery pack of FIG. 2.

FIG. 4 is a cross-sectional view of section 4-4 of FIG. 2.

FIG. 5 is a cross-sectional view of another exemplary traction battery pack.

FIG. 6 is a cross-sectional view of another exemplary traction battery pack.

FIG. 7 is a cross-sectional view of yet another exemplary traction battery pack.

FIG. 8 is a cross-sectional view of yet another exemplary traction battery pack.

FIG. 9 schematically illustrates a sealing performance of a battery enclosure assembly during a battery thermal event of a traction battery pack.

FIG. 10 illustrates an exemplary sealing portion of a protective blanket for a traction battery pack.

FIG. 11 illustrates another exemplary sealing portion of a protective blanket for a traction battery pack.

FIG. 12 illustrates another exemplary sealing portion of a protective blanket for a traction battery pack.

FIG. 13 illustrates yet another exemplary sealing portion of a protective blanket for a traction battery pack.

### DETAILED DESCRIPTION

This disclosure details systems and methods for sealing interfaces of a traction battery pack. An enclosure assembly of the traction battery pack may include a protective blanket configured for insulating portions of the enclosure assembly. A sealing portion of the protective blanket may be arranged to seal an interface between a first enclosure section and a second enclosure section of the enclosure assembly. The sealing portion may be compressed by one or more mechanical fasteners for sealing a gas exchange between an interior area of the enclosure assembly and an ambient environment outside of the enclosure assembly. These and other features are discussed in greater detail in the following paragraphs of this detailed description.

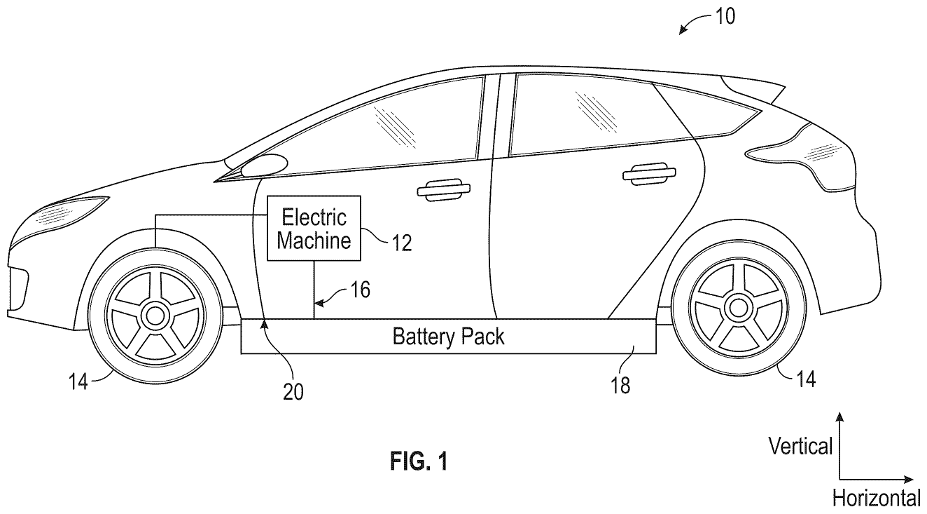

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

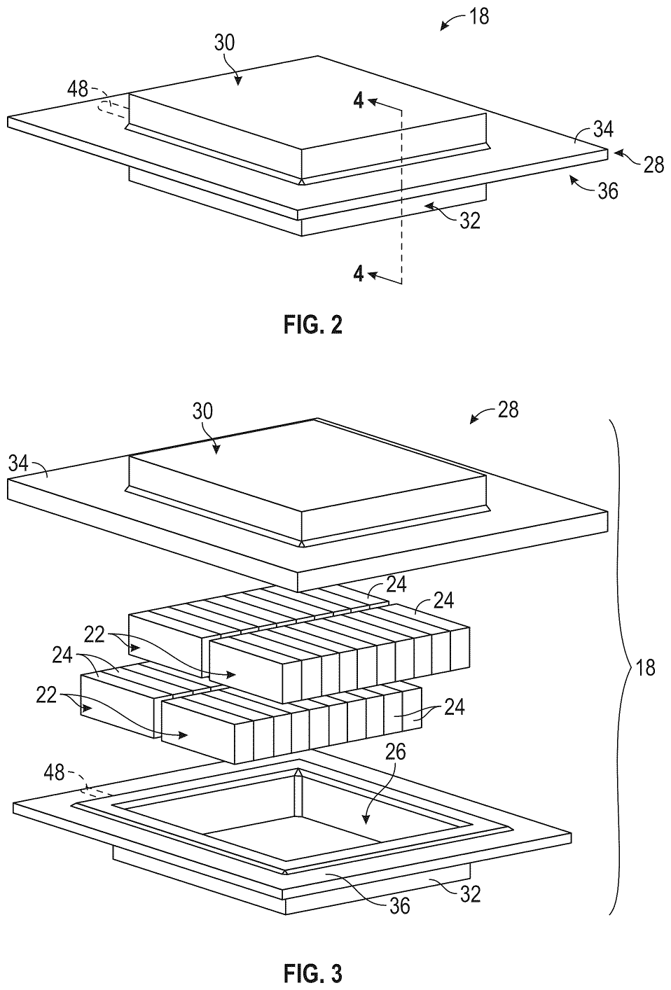

FIGS. 2, 3, and 4 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The total number of battery arrays 22 and battery cells 24 provided within the traction battery pack 18 is not intended to limit this disclosure.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

The enclosure cover 30 may include a first peripheral flange 34 that projects outward from the interior area 26, and the enclosure tray 32 may include a second peripheral flange 36 that projects outward from the interior area 26. The first peripheral flange 34 and the second peripheral flange 36 project horizontally in this example, but could project in other directions. Horizontal and vertical, for purposes of this disclosure, are with reference to ground in a general orientation of the traction battery pack 18 when installed on the electrified vehicle 10 of FIG. 1.

The enclosure cover 30 and the enclosure tray 32 may be metallic or metallic alloy structures. However, other materials or combinations of materials could be utilized within the scope of this disclosure. One or both of the enclosure cover 30 and enclosure tray 32 could be a stamping, an extruded component, or a diecast component, for example.

The enclosure assembly 28 may be configured to hold battery arrays 22 in both a first, lower tier T1 and a second, upper tier T2 that is vertically above the first tier T1. However, the enclosure assembly 28 could alternatively be configured to hold only a single tier of battery arrays 22 (see FIG. 5) or more than two tiers of battery arrays 22.

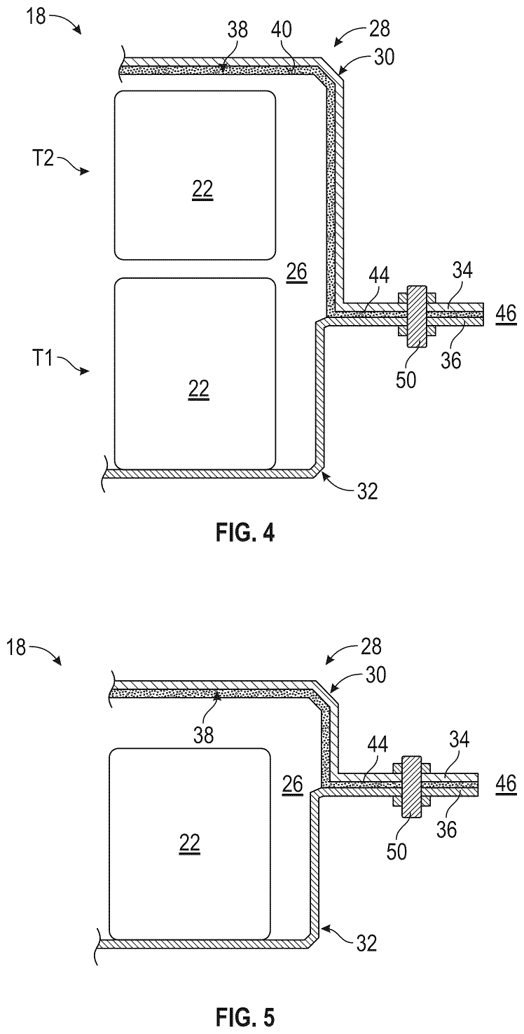

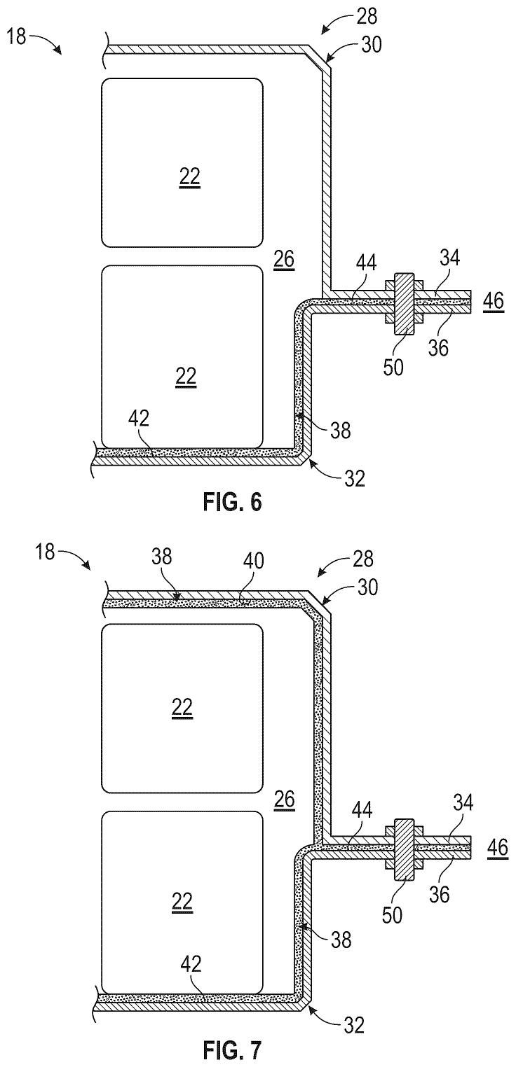

Referring now primarily to FIG. 4, with continued reference to FIGS. 2-3, one or more portions of the enclosure assembly 28 may be lined with a protective blanket 38. The protective blanket 38 is therefore disposed within the interior area 26 of the enclosure assembly 28. In an embodiment, an interior surface 40 of the enclosure cover 30 is lined with the protective blanket 38. In another embodiment, an interior surface 42 of the enclosure tray 32 is lined with the protective blanket 38 (see FIG. 6). In yet another embodiment, both the interior surface 40 of the enclosure cover 30 and the interior surface 42 of the enclosure tray 32 are lined with the protective blanket 38 (see FIG. 7). The protective blanket 38 may be secured relative to the interior surface 40 and/or the interior surface 42 by an adhesive or other suitable fastener.

The protective blanket 38 may be configured to block the transfer of thermal energy from the battery arrays 22 to the enclosure assembly 28, thereby limiting battery vent gases and other effluents and their associated heat from influencing the structural integrity of the enclosure cover 30 and/or the enclosure tray 32, such as during a battery thermal event, for example. The protective blanket 38 may embody a blanket-like design and can be made of a flame resistant and heat insulating material. In an embodiment, the protective blanket 38 is a mica sheet. However, the protective blanket 38 could be made of aerogel materials, refractory ceramic fibers, or other materials or combinations of materials that are capable of providing flame resistant and heat insulation properties.

A sealing portion 44 of the protective blanket 38 may be disposed between the first peripheral flange 34 of the enclosure cover 30 and the second peripheral flange 36 of the enclosure tray 32. The sealing portion 44 may be an integrated part of the protective blanket 38 that is arranged to extend circumferentially continuously about a perimeter of the interior area 26. The sealing portion 44 may be compressed between the first peripheral flange 34 and the second peripheral flange 36 for blocking moisture and contaminants from entering the interior area 26 from an ambient environment 46 outside of the traction battery pack 18.

The sealing portion 44 may further seal a gas exchange between the interior area 26 and the ambient environment 46. For example, if a battery thermal event in the interior area 26 results in increased thermal energy and vented gas, the compressed sealing portion 44 located between the first peripheral flange 34 and the second peripheral flange 36 of the enclosure assembly 28 may block vented gas and thermal energy from exiting the interior area 26 along the interface between the first and second peripheral flanges 34, 36. This can help maintain the integrity of the enclosure assembly 28 and ensure that the vented gas and thermal energy is expelled from the interior area 26 at a desired area, such as through a dedicated vent port 48 (see FIGS. 2 and 3), for example.

The first peripheral flange 34 and the second peripheral flange 36 may be joined together by one or more mechanical fasteners 50. In an embodiment, a plurality of mechanical fasteners 50 are provided along an outer circumference of the enclosure assembly 28 of the traction battery pack 18 to join the first peripheral flange 34 and the second peripheral flange 36, and thus the enclosure cover 30 and the enclosure tray 32, together.

The mechanical fasteners 50 may be bolts or any other suitable mechanical fastener. The mechanical fasteners 50 may be tightened down to compress the sealing portion 44 between the first peripheral flange 34 and the second peripheral flange 36 and thus seal the gas exchange between the interior area 26 and the ambient environment 46. When inserted, the mechanical fasteners 50 may pass through each of the first peripheral flange 34, the sealing portion 44, and the second peripheral flange 36.

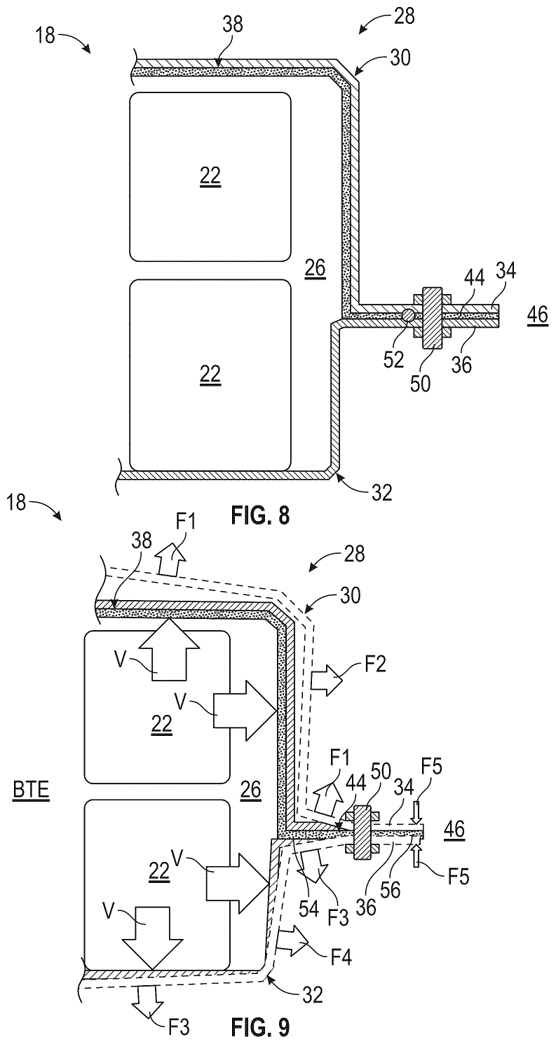

Optionally, a sealant 52 (e.g., adhesive, foam, room temperature vulcanized silicone sealant, etc.) may be applied along the interface between the first peripheral flange 34 and the second peripheral flange 36 at a location that is between the interior area 26 and the mechanical fastener 50 (see FIG. 8). The sealant 52 may be provided immediately adjacent to the mechanical fastener 50, for example. The sealant 52 may be provided to augment the sealing integrity provided by the sealing portion 44 of the protective blanket 38.

FIG. 9 schematically illustrates a sealing performance of the sealing portion 44 of the protective blanket 38 during a battery thermal event BTE. For example, during the battery thermal event BTE, vent gases V released by one or more of the battery arrays 22 may force the enclosure cover 30 upward and to the right (as indicated by arrows F1 and F2, respectively), and may force the enclosure tray 32 downward and to the right (as indicated by arrows F3 and F4, respectively). As a result, a first section 54 of the sealing portion 44 that is located inboard of the mechanical fastener(s) 50 may decompress and be left exposed to the vent gases V. However, a second section 56 of the sealing portion 44 that is located outboard of the mechanical fastener(s) 50 will be further compressed (as indicated by arrows F5) by the forces acting on the enclosure cover 30 and the enclosure tray 32, thereby preserving the sealed interface to prevent the vent gases V from escaping between the first and second peripheral flanges 34, 36 to the ambient environment 46.

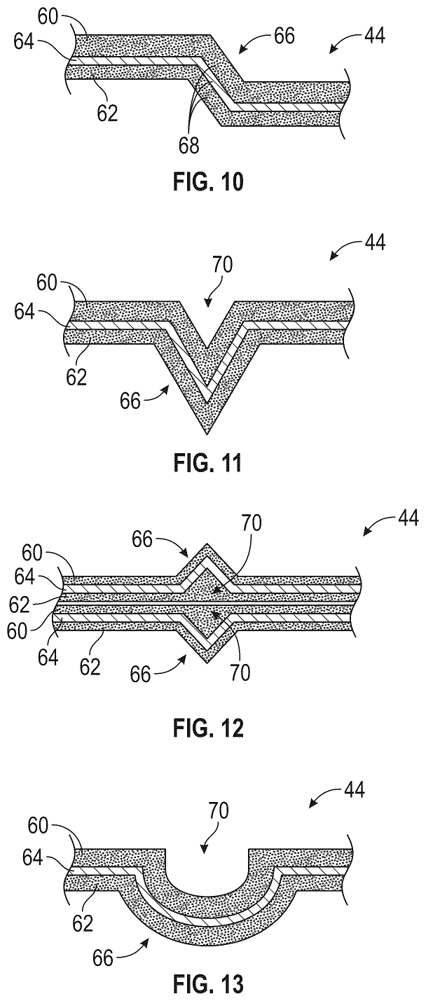

FIGS. 10-13 illustrates additional design features that can be incorporated into the sealing portion 44 of the protective blanket. The sealing portion 44 may be a multi-layered structure that includes a first layer 60, a second layer 62, and a third layer 64. The first layer 60 and the second layer 62 may each be thermally insulating layers of the sealing portion 44. Although two thermally insulating layers are shown in the exemplary embodiments, the sealing portion 44 described herein could include two or more thermally insulating layers within the scope of this disclosure.

The first and second layers 60, 62 may be made of one or more thermally resistant (and thus low thermal conductivity) materials such as mica, aerogel materials, refractory ceramic fibers, etc. However, other materials or combinations of materials could with utilized to provide the thermally resistant material of each of the first and second layers 60, 62.

The third layer 64 may be sandwiched between the first layer 60 and the second layer 62. In an embodiment, the third layer 64 may be a metallic (e.g., aluminum, etc.) layer configured for increasing the rigidity of the sealing portion 44. In another embodiment, the third layer 64 may be an additional thermally insulating layer of the sealing portion 44.

The various layers 60, 62, and 64 of the sealing portion 44 may cooperate to establish one or more geometric features 66 within the scaling portion 44. The geometric feature 66 may be configured to increase the sealing load achieved by the sealing portion 44 when it is compressed between the first and second peripheral flanges 34, 36 of the enclosure assembly 28 in the manner shown in FIGS. 4-8. Increasing the sealing load enhances the ability of the sealing portion 44 to withstand any potential gap movement between the first and second peripheral flanges 34, 36 during battery thermal events.

In an embodiment, the geometric feature 66 may be established by forming angled surfaces 68 in each of the first layer 60, the second layer 62, and the third layer 64 (see, e.g., FIG. 10). In another embodiment, the geometric feature 66 may be established by forming one or more indentations 70 in each of the first layer 60, the second layer 62, and the third layer 64 (see, e.g., FIGS. 11, 12, and 13). The geometric feature 66 could embody various shapes, including but not limited to a Z-shape (see FIG. 10), a V-shape (see FIGS. 11 and 12), and a U-shape (see FIG. 13).

The exemplary traction battery packs of this disclosure incorporate protective blankets for insulating an outer enclosure assembly. The protective blankets may include a sealing portion that can be arranged to seal an interface between peripheral flanges of the enclosure assembly. The protective blankets can thus provide a gasketless arrangement capable of sealing a gas exchange between an interior area of the traction battery pack and a surrounding ambient environment. Sealing performance of the protective blankets may be enhanced by incorporating geometrical features into the sealing portion that is sandwiched and compressed between the peripheral flanges.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including a first enclosure section and a second enclosure section;
a protective blanket positioned to line at least a portion of the first enclosure section or the second enclosure section; and
a sealing portion of the protective blanket arranged to extend between a first peripheral flange of the first enclosure section and a second peripheral flange of the second enclosure section.

2. The traction battery pack as recited in claim 1, comprising a mechanical fastener inserted through the first peripheral flange, the sealing portion, and the second peripheral flange.

3. The traction battery pack as recited in claim 2, wherein the mechanical fastener includes a bolt.

4. The traction battery pack as recited in claim 2, wherein the sealing portion is compressed between the first peripheral flange and the second peripheral flange by the mechanical fastener.

5. The traction battery pack as recited in claim 2, comprising a sealant disposed between the first peripheral flange and the second peripheral flange at a location adjacent to the mechanical fastener.

6. The traction battery pack as recited in claim 1, wherein the first enclosure section is an enclosure cover, and the second enclosure section is an enclosure tray.

7. The traction battery pack as recited in claim 6, wherein the protective blanket lines an interior surface of the enclosure cover.

8. The traction battery pack as recited in claim 6, wherein the protective blanket lines an interior surface of the enclosure tray.

9. The traction battery pack as recited in claim 1, wherein the sealing portion is configured to seal a gas path that extends between the first peripheral flange and the second peripheral flange.

10. The traction battery pack as recited in claim 1, wherein the sealing portion includes a first thermally insulating layer, a second thermally insulating layer, and a third layer sandwiched between the first thermally insulating layer and the second thermally insulating layer.

11. The traction battery pack as recited in claim 10, wherein the third layer is a metallic layer or an additional thermally insulating layer.

12. The traction battery pack as recited in claim 10, wherein the first thermally insulating layer, the second thermally insulating layer, and the third layer cooperate to establish a geometric feature within the sealing portion.

13. The traction battery pack as recited in claim 12, wherein the geometric feature is established by an angled surface or an indentation formed in each of the first thermally insulating layer, the second thermally insulating layer, and the third layer.

14. A traction battery pack, comprising:
an enclosure assembly including a first enclosure section and a second enclosure section that cooperate to establish an interior area;
a protective blanket secured to an interior surface of at least one of the first enclosure section or the second enclosure section;
a sealing portion of the protective blanket extending between a first peripheral flange of the first enclosure section and a second peripheral flange of the second enclosure section, wherein the sealing portion is configured to seal a gas exchange between the interior area and an ambient environment outside of the enclosure assembly; and
a mechanical fastener configured to compress the sealing portion between the first peripheral flange and the second peripheral flange.

15. The traction battery pack as recited in claim 14, comprising a first battery array and a second battery array housed within the interior area.

16. The traction battery pack as recited in claim 15, wherein the first battery array is part of a first tier of battery arrays, and the second battery array is part of a second tier of battery arrays.

17. The traction battery pack as recited in claim 14, wherein the protective blanket is a mica sheet.

18. The traction battery pack as recited in claim 14, comprising a sealant disposed between the first peripheral flange and the second peripheral flange at a location adjacent to the mechanical fastener.

19. The traction battery pack as recited in claim 14, wherein the sealing portion includes a first thermally insulating layer, a second thermally insulating layer, and a metallic layer sandwiched between the first thermally insulating layer and the second thermally insulating layer.

20. The traction battery pack as recited in claim 19, wherein the first thermally insulating layer, the second thermally insulating layer, and the metallic layer cooperate to establish a geometric feature within the scaling portion.
